(19) United States
(12) Patent Application Publication
(10) Pub. No.: US 2017/0160126 A1
(43) Pub. Date: Jun. 8, 2017

(54) Device For Determining a Speed of a Sound Signal in a Fluid

(71) Applicant: Continental Automotive GmbH, Hannover (DE)

(72) Inventors: Karl-Friedrich Pfeiffer, Erlangen (DE); Claus Weber, Zirndorf (DE); Henning Grotevent, Nuernberg (DE); Wighard Jaeger, Spardorf (DE)

(73) Assignee: Continental Automotive GmbH, Hannover (DE)

(21) Appl. No.: 15/127,127

(22) PCT Filed: Jul. 6, 2015
(86) PCT No.: PCT/EP2015/065400

§ 371 Date: Sep. 19, 2016

(30) Foreign Application Priority Data
Jul. 8, 2014 (DE) 10 2014 213 233.9

(51) Int. Cl. G01H 5/00; G01N 29/22; G01N 29/024

(52) U.S. Cl. CPC G01H 5/00; G01N 29/024; G01N 29/222

(57) ABSTRACT

The present disclosure relates to sensors, and the teaching may be applied to a device for determining a speed of a sound signal in a fluid in a fluid container. A device may include: a sound transducer for transmitting and receiving sound; a first reflector element and a second reflector element integrally formed in a reference element to reflect sound generated by the sound transducer back to the sound transducer; and a control unit operating to: ascertain a first signal runtime related to a first reflection of the sound signal from the first reflector element; a second signal runtime related to of a second reflection of the sound signal from the second reflector element; and calculate the speed as a function of the two.

### CROSS-REFERENCE TO RELATED APPLICATIONS

This application is a U.S. National Stage Application of International Application No. PCT/EP2015/065400 filed Jul. 6, 2015, which designates the United States of America, and claims priority to DE Application No. 10 2014 213 233.9 filed Jul. 8, 2014, the contents of which are hereby incorporated by reference in their entirety.

### TECHNICAL FIELD

The present disclosure relates to sensors, and the teaching may be applied to a device for determining a speed of a sound signal in a fluid in a fluid container.

### BACKGROUND

To determine the speed of a sound signal in a fluid in a fluid container, a sound transducer may be used both as a sound generator and also as a sound receiver. For a determination of the speed of the sound signal in the fluid, sound pulses can be emitted into the fluid to be measured by means of the sound transducer. Conclusions can be drawn about the speed of sound of the sound signal in the fluid from the runtime of the sound pulses.

Document US 2009/0158821 A1 describes a device for measuring one or more ultrasound parameters of a suspension comprising particles dissolved in a liquid carrier. The device comprises one or more ultrasound sensors for emitting and receiving ultrasonic waves and one or more reflectors, which have at least one reflective surface and are arranged to reflect the ultrasonic waves to the ultrasound sensors. The device furthermore comprises a housing which fixes the ultrasound sensors and reflectors spaced apart from one another, comprising an opening in the housing, which enables the suspension to flow into the intermediate space between ultrasound sensors and reflectors.

Document DE 10 2012 207 732 A1 describes a method for ascertaining the speed of ultrasound in a liquid located in a housing with the aid of an ultrasound sensor along a measurement section having a first reference point and a second reference point arranged above it. With a fill level significantly higher than the second reference point, the speed of ultrasound is ascertained by measurement of the runtime difference between the two reference points in the case of known distance between the two reference points. With a fill level approaching the second reference point, the speed of ultrasound is ascertained, the runtime to the first reference point is measured, and the distance of the first reference point from the ultrasound sensor is calibrated. With a liquid level below the second reference point, the runtime up to the first reference point is measured and the calibrated distance is used to calculate the speed of ultrasound.

Document US 2012/0118059 A1 describes a system for determining a quality or a quantity of fluid in a tank, in which a sound transducer is arranged in the vicinity of the bottom of the tank, so that sound is oriented in the direction of a fixed object having known distance. The system furthermore comprises a temperature sensor for detecting a temperature of the fluid and a control unit, which is designed to conclude a soiling of the fluid as a function of the temperature of the fluid and a runtime of the sound signal.

Document U.S. Pat. No. 4,679,175 A describes an ultrasonic distance measuring method and a device, in which a sound transducer periodically transmits a pair of bundles of acoustic energy along an acoustic path toward a target object and an echo of the first acoustic bundle of each bundle pair is used to ascertain a peak reference level, and an echo of the second bundle of each bundle pair is used to determine a distance to the target object if its level exceeds a predefined fraction of the peak reference level.

Document U.S. Pat. No. 5,604,301 A describes a method for separating a liquid and an ultrasound particle detection device having a transmitter, receiver, and reflector immersed in the liquid.

Document U.S. Pat. No. 6,330,831 B1 describes a measurement system for determining a physical property of a fluid, wherein the system carries out measurements of an ultrasonic signal, which propagates through the fluid toward a reflector in the fluid, and includes at least one reflection measurement, wherein the ultrasonic signal propagates along a differential path in the fluid which is suitable for determining a value of the fluid impedance locally at the reflector.

### SUMMARY

The teachings of the present disclosure may provide a cost-effective and reliable device for determining a speed of sound in a fluid, which enables a high accuracy in the determination of the speed of sound.

In some embodiments, a device for determining a speed of sound in a fluid (1) in a fluid container (3), may comprise: a sound transducer (5), which is designed for transmitting and receiving sound, a first reflector element (7), which is arranged at a first distance (D1) to the sound transducer (5) in a fluid chamber (11) of the fluid container (3), at least one further reflector element (13, 15), which is arranged at a respective predefined further distance (D2, D3) to the first reflector element (7) in the fluid chamber (11) of the fluid container (3), wherein the first reflector element (7) and the at least one further reflector element (13, 15) are integrally formed in a reference element (17) and are designed to reflect sound generated by the sound transducer (5) back to the sound transducer (5), wherein the reference element (17) is fixedly coupled to a bottom portion (9) of the fluid container (3) in a coupling region of the reference element (17), and a control unit (19), which is designed to: control the sound transducer (5) such that a predefined sound signal (S) is generated, the main radiation direction (HSR) of which extends in parallel to the bottom portion (9) of the fluid container (3), ascertain a first signal runtime between a transmission time of the sound signal (S) and a reception time of a first reflection of the sound signal (S) on the first reflector element (7), ascertain a respective further signal runtime between the transmission time of the sound signal (S) and a reception time of a respective further reflection of the sound signal (S) on the respective further reflector element (13, 15), and ascertain the speed of sound of the sound signal (S) within the fluid (1) as a function of the first signal runtime and the respective further signal runtime.

In some embodiments, the coupling region of the reference element (17) has at least one recess (19).

In some embodiments, the coupling region of the reference element (17) has at least one borehole (21).

In some embodiments, the coupling region of the reference element (17) is extrusion-coated using plastic.

In some embodiments, the reference element (17) is designed as rising monotonously protruding into the fluid chamber (11) proceeding from a side of the first reflector element (7) facing toward the sound transducer (5) in the main radiation direction (HSR) of the sound signal (S) toward a side of the at least one further reflector element (13, 15) facing away from the sound transducer (5).

In some embodiments, a subregion of the reference element (17) protruding into the fluid chamber (11) is formed as a plane in parallel to the main radiation direction (HSR) of the sound signal (S) between two successive reflector elements (7, 13, 15) in the main radiation direction (HSR) of the sound signal (S).

In some embodiments, the reference element (17) is formed from a metal.

### BRIEF DESCRIPTION OF THE DRAWINGS

Exemplary embodiments of the invention are explained hereafter on the basis of the schematic drawings. In the figures:

FIG. 1 shows a first exemplary embodiment of a device for determining a speed of sound of a fluid,

FIG. 2 shows a second exemplary embodiment of a device for determining the speed of sound of the fluid, and

FIG. 3 shows a third exemplary embodiment of a device for determining the speed of sound of the fluid.

Elements of identical design or function are provided with the same reference signs throughout the figures.

### DETAILED DESCRIPTION

The teachings of the present disclosure may be applied to a device for determining a speed of sound in a fluid in a fluid container, which comprises a sound transducer designed for transmitting and receiving sound.

In some embodiments, the device comprises a first reflector element arranged at a first distance to the sound transducer in a fluid chamber of the fluid container. Furthermore, the device comprises at least one further reflector element, which is arranged at a respective predefined further distance to the first reflector element in the fluid chamber of the fluid container.

In some embodiments, the first reflector element and the at least one further reflector element are integrally formed in a reference element. The first reflector element and the at least one further reflector element are designed to reflect sound generated by the sound transducer back to the sound transducer.

In some embodiments, the device comprises a control unit designed to control the sound transducer such that a predefined sound signal is generated, the main radiation direction of which extends in parallel to a bottom portion of the fluid container. Furthermore, the control unit is designed to ascertain a first signal runtime between a transmission time of the sound signal and a reception time of a first reflection of the sound signal on the first reflector element. Furthermore, the control unit is designed to ascertain a respective further signal runtime between the transmission time of the sound signal and a reception time of a respective further reflection of the sound signal on the respective further reflector element. Furthermore, the control unit is designed to ascertain the speed of sound of the sound signal within the fluid as a function of the first signal runtime and the respective further signal runtime.

Some embodiments include an arrangement of at least two reflector elements in the fluid chamber which provides that only a distance between the first reflector element and the at least one further reflector element has to be known to determine the speed of sound of the sound signal in the fluid.

In some embodiments, the integral formation of the reflector elements enables a simple installation of the reflector elements. Furthermore, the integral formation of the reflector elements contributes to the respective predefined further distance being essentially independent of installation, aging, and temperature. Furthermore, for example, a calibration of the device is thus merely optional.

In some embodiments, the integral formation of the reflector elements contributes to a replacement or a change of a reflector element, for example, because of the application or a defect, being essentially independent of the fluid container, the control unit, and the sound transducer.

In some embodiments, the reference element is fixedly coupled to the fluid container in a coupling region of the reference element.

In some embodiments, the reference element is fixedly coupled to the bottom portion of the fluid container in the coupling region of the reference element. This enables a determination of the speed of sound even with a low fill level of the fluid container.

In some embodiments, the coupling region of the reference element has at least one recess. This enables a formfitting connection of the reference element to the fluid container. Furthermore, a surface of the reference element is enlarged such that a material bond having a high reliability is enabled.

In some embodiments, the coupling region of the reference element has at least one borehole. This enables a formfitting and/or friction-locked connection of the reference element to the fluid container. Furthermore, a surface of the reference element is enlarged such that a material bond having high reliability is enabled.

For example, the bottom portion of the fluid container has at least one fastening pin in this context, which is designed for staking with the coupling region of the reference element in the scope of a production of a coupling to the coupling region of the reference element.

In some embodiments, the coupling region of the reference element is extrusion-coated using plastic. This enables a cost-effective and robust mechanical coupling of the reference element to the fluid container.

In some embodiments, the reference element is designed as rising monotonously protruding into the fluid chamber proceeding from a side of the first reflector element facing toward the sound transducer in the main radiation direction of the sound signal toward a side of the at least one further reflector element facing away from the sound transducer. Such an arrangement contributes to an operation of the device essentially free of an interfering reflection between a side facing toward the sound transducer and a side facing away from the sound transducer of two reflector elements in succession in the main radiation direction of the sound signal.

Furthermore, the arrangement contributes, in the case of a fluid which expands as a result of temperature, and which is frozen in particular, for example, to a reflector element situated closer to the sound transducer of two successive reflector elements in the main radiation direction of the sound signal being substantially free of a force applied to its side facing away from the sound transducer of the expanding fluid, which is opposite to a force of the expanding fluid applied to a side facing toward the sound transducer of a reflector element arranged more remotely from the sound transducer, so that the respective predefined further distance between the two reflector elements remains unchanged.

In some embodiments, a subregion of the reference element protruding into the fluid chamber is formed as a plane in parallel to the main radiation direction of the sound signal between two successive reflector elements in the main radiation direction of the sound signal. Such an arrangement enables an operation of the device essentially free of a reflection on the subregion of the reference element protruding into the fluid chamber between the two successive reflector elements in the main radiation direction of the sound signal, so that this contributes to a high efficiency of the device.

In some embodiments, the reference element is formed from a metal. A reliable reflection of the sound signals on the reflector elements of the reference element is thus enabled. Furthermore, the reference element is thus robust in relation to a force action, so that the respective predefined further distance remains unchanged essentially independently of aging and a temperature change.

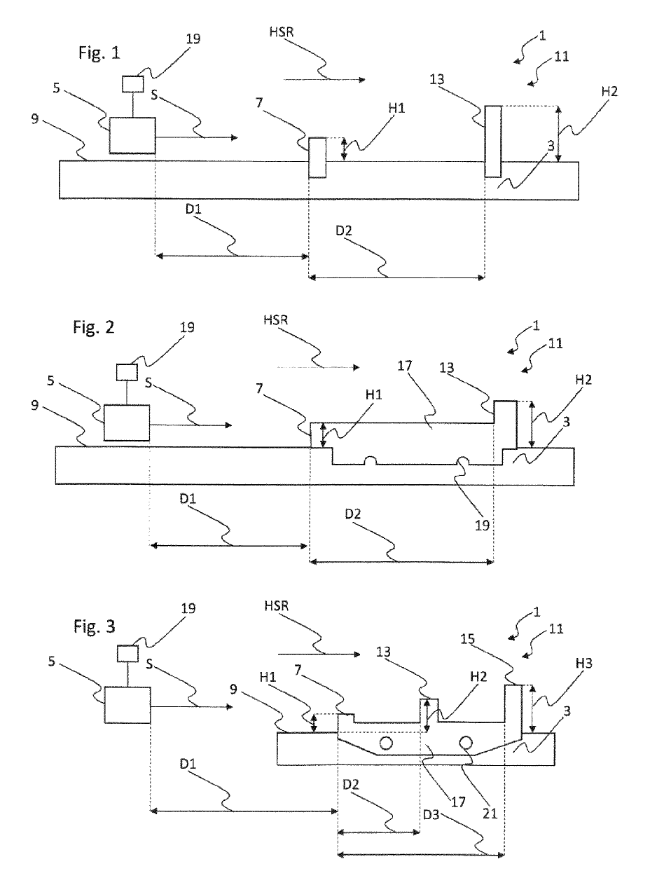

FIG. 1 shows a device for determining a speed of sound in a fluid 1, comprising a fluid container 3 having a bottom section 9 and a fluid chamber 11, which is filled with the fluid 1. The fluid 1 is, for example, a liquid medium for pollutant reduction in exhaust gases, which may include a reducing agent and/or a reducing agent precursor, for example, an aqueous urea solution.

For example, to determine a fill level of the fluid 1 in the fluid chamber 11 by means of sound, a known speed of sound of a predefined sound signal S in the fluid 1 is required. For this purpose, for example, a sound transducer 5, which is designed to transmit and receive sound, is arranged in the fluid chamber 11. The sound transducer 5 can furthermore be coupled, for example, through a housing wall of the fluid container 3 on the fluid chamber 11.

The sound transducer 5 is controlled by a control unit 19 to generate the predefined sound signal S.

To determine the speed of sound of the sound signal S in the fluid 1, in the main radiation direction HSR of the sound signal S, a first reflector element 7 is arranged at a first distance D1 to the sound transducer 5 in the fluid chamber 11 of the fluid container 3, which is designed to reflect the sound generated by the sound transducer 5 back to the sound transducer 5.

The control unit 19 is designed to ascertain a first signal runtime between a transmission time of the sound signal S and a reception time of a first reflection of the sound signal S at the first reflector element 7. In the case that the first distance D1 is known sufficiently accurately, for example, on the basis of a low manufacturing tolerance or by a calibration, the speed of sound of the sound signal S within the fluid 1 can thus already be ascertained as a function of the first signal runtime.

An error can occur in the determination of the speed of sound of the sound signal S within the fluid 1 due to a temperature-related induced variation of the first distance D1, for example, due to a temperature-dependent signal runtime on an intermediate layer between the sound transducer 5 and the fluid 1, or due to aging effects, for example, due to settling of elastic components or shrinking.

For this reason, a further reflector element 13 is arranged in the fluid chamber 11 of the fluid container 3 at a respective predefined further distance D2 to the first reflector element 7, which further reflector element is designed to reflect the sound generated by the sound transducer 5 back to the sound transducer 5. For example, the reflector elements 7, 13 are fixedly coupled to the bottom portion 9 of the fluid container 3, wherein the first reflector element 7 has a first height H1 in relation to the bottom portion 9, with which the first reflector element 7 protrudes into the fluid chamber 11, and the further reflector element 13 has a further height H2, with which it protrudes into the fluid chamber 11. The first height H1 is, for example, less than the further height H2, so that the predefined sound signal S, the main radiation direction HSR of which extends in parallel to the bottom portion 9 of the fluid container 3, for example, is reflected both at the first reflector element 7 and also at the further reflector element 13.

The control unit 19 is designed to ascertain a further signal runtime between the transmission time of the sound signal S and a reception time of a further reflection of the sound signal S at the further reflector element 13. To determine the speed of sound of the sound signal S in the fluid 1, for example, a difference between the first signal runtime and the further signal runtime can now be ascertained, so that the speed of sound of the sound signal S can be ascertained as a function of the further distance D2.

This has the advantage that only the predefined further distance D2 between the first reflector element 7 and the further reflector element 13 has to be known. For example, the temperature-related induced variation of the first distance D1 is thus compensated for.

The further distance D2 between the first reflector element 7 and the further reflector element 13 still has to be known with a high accuracy or calibrated in this case, however. Because of aging, installation, or temperature, it is not ensured that this condition is always fulfilled.

A second exemplary embodiment (FIG. 2) differs from the first exemplary embodiment in that the two reflector elements 7, 13 are integrally formed in a reference element 17.

It can thus be ensured that the further distance D2 between the first reflector element 7 and the further reflector element 13 remains substantially constant independently of temperature, installation, and aging. The further distance D2, and also an alignment of the reflector elements 7, 13 in relation to one another, is only dependent on a manufacturing of the reference element 17 in this case.

A calibration of the device is solely optional in this case, for example, because the further distance D2 is already sufficiently known before an installation of the device either on the basis of manufacturing tolerances of the reference element 17 or by measurement.

Furthermore, an integral formation of the reflector elements 7, 13 in the reference element 17 contributes to a simplified installation of the reflector elements 7, 13 in relation to the first exemplary embodiment, because only a single component has to be installed. This additionally enables, for example, a change caused by application or defect on the reference element 17 to be carried out substantially independently of the fluid container 3, the sound transducer 5, and the control unit 19.

For installation of the reference element 17, it has at least one recess 19 in a coupling region, for example. This enables, for example, a formfitting connection of the reference element 17 to the fluid container 3. Furthermore, a surface of the reference element 17 is enlarged such that a material bond having high reliability is enabled. For example, the coupling region of the reference element 17 is extrusion-coated using plastic for this purpose.

For example, the reference element 17 is formed as rising monotonously protruding into the fluid chamber 11 proceeding from a side of the first reflector element 7 facing toward the sound transducer 5 in the main radiation direction HSR of the sound signal S toward a side of the further reflector element 13 facing away from the sound transducer 5. In particular a subregion of the reference element 17 is formed in this case as a plane in parallel to the main radiation direction HSR of the sound signal S protruding into the fluid chamber 11 between the first reflector element 7 and the further reflector element 13.

In such embodiments, the further reflection of the sound signal S at the further reflector element 13 is reflected back to the sound transducer 5 substantially independently of the first reflector element 7. Substantially no interfering reflections thus occur between the two reflector elements 7, 13, so that this contributes to an efficiency of the device, for example.

In the case of a fluid 1 which expands as a result of temperature, for example, in particular is frozen, for example, a first force of the expanding fluid is applied to a side of the further reflector element 13 facing toward the sound transducer 5. In contrast to the first exemplary embodiment, however, due to a monotonously rising formation of the reference element 17, no force oriented opposite to the first force of the expanding fluid is applied to the side of the first reflector element 7 facing away from the sound transducer, so that the further distance D2 between the first reflector element 7 and the further reflector element 13 remains essentially constant.

The third exemplary embodiment (FIG. 3) differs from the second exemplary embodiment in that the reference element 17 has at least one borehole 21 in the coupling region. For example, the bottom portion 9 of the fluid container 3 has at least one fastening pin, which is formed for staking with the coupling region in the scope of a production of a coupling with the coupling region of the reference element. Alternatively or additionally, the coupling region of the reference element 17 is extrusion-coated using plastic, for example.

Furthermore, the reference element 17 comprises the first reflector element 7, which is arranged at the first distance D1 to the sound transducer 5 and protrudes with the first height H1 into the fluid chamber 11, and at least one further reflector element 13, 15, which is arranged at a respective further distance D2, D3 to the first reflector element 7 and protrudes with a respective further height H2, H3 into the fluid chamber, such that the sound generated by the sound transducer 5 is reflected in each case back to the sound transducer 5 by the reflector elements 7, 13, 15.

For example, the reference element 17 is manufactured from a metal, so that the respective further distance D2, D3 between the at least one reflector element 13, 15 and the first reflector element 7 is substantially constant independent of temperature and aging.

What is claimed is:

1. A device for determining a speed of sound traveling through a fluid in a fluid container, the device comprising:
a sound transducer for transmitting and receiving sound;
a first reflector element arranged at a first distance from the sound transducer in a fluid chamber of the fluid container;
a second reflector element arranged at a second distance beyond the first reflector element in the fluid chamber of the fluid container;
wherein the first reflector element and the second reflector element are integrally formed in a reference element and reflect sound generated by the sound transducer back to the sound transducer;
wherein the reference element is fixedly coupled to a bottom portion of the fluid container at a coupling region of the reference element; and
a control unit operating to:
generate a predefined sound signal with the sound transducer, the main radiation direction of which extends in parallel to the bottom portion of the fluid container;
ascertain a first signal runtime between a transmission time of the sound signal and a first reception time of a first reflection of the sound signal from the first reflector element;
ascertain a second signal runtime between the transmission time of the sound signal and a second reception time of a second reflection of the sound signal from the second reflector element; and
calculate the speed of the sound signal through the fluid as a function of the first signal runtime and the second signal runtime.

2. The device as claimed in claim 1, wherein the coupling region of the reference element includes at least one recess.

3. The device as claimed in claim 1, wherein the coupling region of the reference element includes at least one borehole.

4. The device as claimed in claim 1, wherein the coupling region of the reference element is extrusion-coated with plastic.

5. The device as claimed in claim 1, wherein the reference element rises monotonously protruding into the fluid chamber proceeding from a side of the first reflector element facing toward the sound transducer in the main radiation direction of the sound signal toward a side of the at least one further reflector element facing away from the sound transducer.

6. The device as claimed in claim 5, wherein a subregion of the reference element protruding into the fluid chamber includes a plane parallel to the main radiation direction of the sound signal between the two reflector elements in the main radiation direction of the sound signal.

7. The device as claimed in claim 1, wherein the reference element comprises a metal.
